(19) United States
(12) Patent Application Publication
(10) Pub. No.: US 2024/0193049 A1
(43) Pub. Date: Jun. 13, 2024

(54) RANSOMWARE RECOVERY SYSTEM

(71) Applicant: VMware, Inc., Palo Alto, CA (US)

(72) Inventors: Boris WEISSMAN, Palo Alto, CA (US); Bharath Kumar CHANDRASEKHAR, Sunnyvale, CA (US); Kiran KAMATH, San Jose, CA (US); Piyush KOTHARI, San Jose, CA (US); Juan Pablo CASARES-CHARLES, Mountain View, CA (US); Mamta BHAVSAR, San Carlos, CA (US); Ryan Joseph TODD, Chofu (JP); Michael KOLECHKIN, Palo Alto, CA (US); David Aaron KRIEGER, Menlo Park, CA (US); Deepa SREEKUMAR, Sunnyvale, CA (US); Sharath Nagaraj DWARAL, Fremont, CA (US); Kamala Narayan Balasubramanian SHARATH, Mountain View, CA (US); Kedar THIAGARAJAN, Evanston, IL (US); Amol Abhay KHARE, Pune (IN); Leena Shuklendu SOMAN, Pune (IN); Mandar Kashinath NADGOUDA, Pune (IN); Robert James SPEAKER, Barrington, RI (US)

(21) Appl. No.: 18/080,460

(22) Filed: Dec. 13, 2022

(51) Int. Cl. G06F 11/14; G06F 9/455

(52) U.S. Cl. CPC G06F 11/1464; G06F 9/45558; G06F 2009/45587

(57) ABSTRACT

A method for virtual computing instance remediation is provided. Some embodiments include retrieving a first backup of a virtual machine from storage, the first backup comprising configuration information and data of the virtual machine, the configuration information comprising network connectivity information in a first software defined data center (SDDC) running on a first set of host machines. Some embodiments include configuring a second SDDC running on a second set of host machines based on the configuration information, where the second SDDC is network isolated from the first SDDC and powering on the virtual machine from the first backup in the second SDDC. Some embodiments include sending, from the virtual machine to a security platform, behavior information of the virtual machine running in the second SDDC and determining, based on the behavior information, whether the virtual machine running in the second SDDC is infected with malware.

### BACKGROUND

Ransomware and other malware have emerged as a dominant threat to enterprise information technology. Some estimate that 75% of organizations will be affected by ransomware by 2025. In over 50% of cases, organizations affected by ransomware eventually recover data from backups although the cost of recovery in terms of time, complexity, and partial data loss remains high. Because backups are often the only tool for ransomware recovery, new types of attacks evolved to target backup systems themselves.

While recovery from ransomware has similarities with backup restore and disaster recovery, there are also crucial differences that necessitate developing a specialized recovery solution. Unlike in a traditional backup restore, during ransomware recovery, it is impossible to be certain that backups are not infected. Recovery from backups is the last line of defense after prevention has already failed and the most recent backup data is likely compromised. As such, a need exists in the industry.

It should be noted that the information included in the Background section herein is simply meant to provide a reference for the discussion of certain embodiments in the Detailed Description. None of the information included in this Background should be considered as an admission of prior art.

### SUMMARY

A method for virtual computing instance remediation is provided herein. Some embodiments include retrieving a first backup of a virtual machine from storage, the first backup comprising configuration information and data of the virtual machine, the configuration information comprising network connectivity information in a first software defined data center (SDDC) running on a first set of host machines. Some embodiments include configuring a second SDDC running on a second set of host machines based on the configuration information, where the second SDDC is network isolated from the first SDDC and powering on the virtual machine from the first backup in the second SDDC. Some embodiments include sending, from the virtual machine to a security platform, behavior information of the virtual machine running in the second SDDC and determining, based on the behavior information, whether the virtual machine running in the second SDDC is infected with malware.

In another embodiment, a system includes at least one processor and at least one memory. The at least one processor and the at least one memory may be configured to cause the system to retrieve a first backup of a virtual machine from a storage environment, the first backup of the virtual machine comprising data of the virtual machine and network connectivity information of the virtual machine in a first software defined data center (SDDC) running on a first set of host machines, configure a second SDDC running on a second set of host machines based on the network connectivity information, where the second SDDC is network isolated from the first SDDC, and power on the virtual machine from the first backup in the second SDDC. Some embodiments cause the system to send, from the virtual machine to a security platform, behavior information of the virtual machine running in the second SDDC and determine, based on the behavior information, whether the virtual machine running in the second SDDC is infected with malware.

In yet another embodiment, a non-transitory computer-readable medium includes instructions that, when executed by at least one processor of a computing system, cause the computing system to retrieve a first backup of a virtual machine from storage, the first backup of the virtual machine comprising configuration information of the virtual machine and data of the virtual machine, the configuration information comprising network connectivity information of the virtual machine in a first software defined data center (SDDC) running on a first set of host machines, configure a second SDDC running on a second set of host machines based on the configuration information, where the second SDDC is network isolated from the first SDDC, and power on the virtual machine from the first backup in the second SDDC. In some embodiments the computing system may send, from the virtual machine to a security platform, behavior information of the virtual machine running in the second SDDC, determine, based on the behavior information, whether the virtual machine running in the second SDDC is infected with malware and in response to determining that the virtual machine running in the second SDDC is infected with malware, remediate the malware.

These and additional features provided by the embodiments of the present disclosure will be more fully understood in view of the following detailed description, in conjunction with the drawings.

### BRIEF DESCRIPTION OF THE DRAWINGS

FIG. 1A depicts example physical and virtual components in a networking environment in which embodiments of the present application may be implemented.

FIG. 1B depicts a security platform that operates within the networking environment of FIG. 1A, according to an example embodiment of the present application.

FIG. 2 depicts a flowchart for detecting malware, according to an example embodiment of the present application.

FIGS. 3A, 3B depict a flowchart for detecting and remediating malware, according to an example embodiment of the present application.

### DETAILED DESCRIPTION

Aspects of the present application present techniques for detecting and remediating malware, such as ransomware from a virtual machine. Though certain aspects are discussed with respect to virtual machines, it should be understood that similar techniques may be applied for detecting and remediating malware for other devices or virtual computing instances. As an example, some embodiments create backups of one or more virtual machines in a data center. Backups may be stored in any suitable storage, such as a cloud accessible storage, local storage, etc. An isolated recovery environment may be configured to create an isolated sandboxed environment, such as an isolated software defined data center (SDDC), in which to instantiate and run a backup of a virtual machine, so that behavior of the virtual machine can be monitored to determine if there is malware present on the backup. The isolated sandboxed environment is isolated from the actual data center running production virtual machines, such as by isolating a network of the isolated sandboxed environment from the network of the data center, using different hardware resources for the isolated sandboxed environment than used for running the production data center, and/or the like. By using an isolated sandboxed environment to run the virtual machine, any malware activity that occurs due to behavior of the virtual machine in the isolated sandboxed environment beneficially does not affect the production data center.

The virtual machine running in the isolated sandboxed environment may be configured to send behavioral data, such as information about network activity, memory, and processor usage, process execution, and/or the like, to a security platform. The security platform uses behavioral data and/or other data to determine whether the backup of the virtual machine is infected with malware. Based on the whether the virtual machine is infected with malware, remediation of the virtual machine occurs. For example, if the current backup of the virtual machine is infected, earlier backups in time of the virtual machine can be similarly iteratively tested in the isolated sandboxed environment until a non-infected backup is found, and the non-infected backup may then be restored to the production data center. Some embodiments may attempt to remediate an infected backup.

Accordingly, some aspects of this application provide backup integrity, deep backups, sandboxing, security tools, rapid iterations, and low total cost of ownership (TCO). Specifically backups may be separated from the potentially compromised production environment making ransomware leakage to the backup system itself impossible. Additionally, ransomware “dwell time” is the interval between infection and detection. Embodiments provided herein may be able to restore backups prior to infection to avoid reinfection post-recovery.

Because backups could be infected, the backups may not be directly recovered to a production environment. Instead, some embodiments may be configured such that backups are initially restored into an isolated sandboxed execution environment for security analysis. Because modern security tools may utilize behavioral detection of malware, this sandbox isolated recovery environment is able to execute workloads and not just passively store backups.

Some aspects of the application provide integrated security tools for malware detection and removal in the sandbox environment. These security tools may collect data from executing workloads for subsequent analysis to detect behavioral anomalies in the collected data.

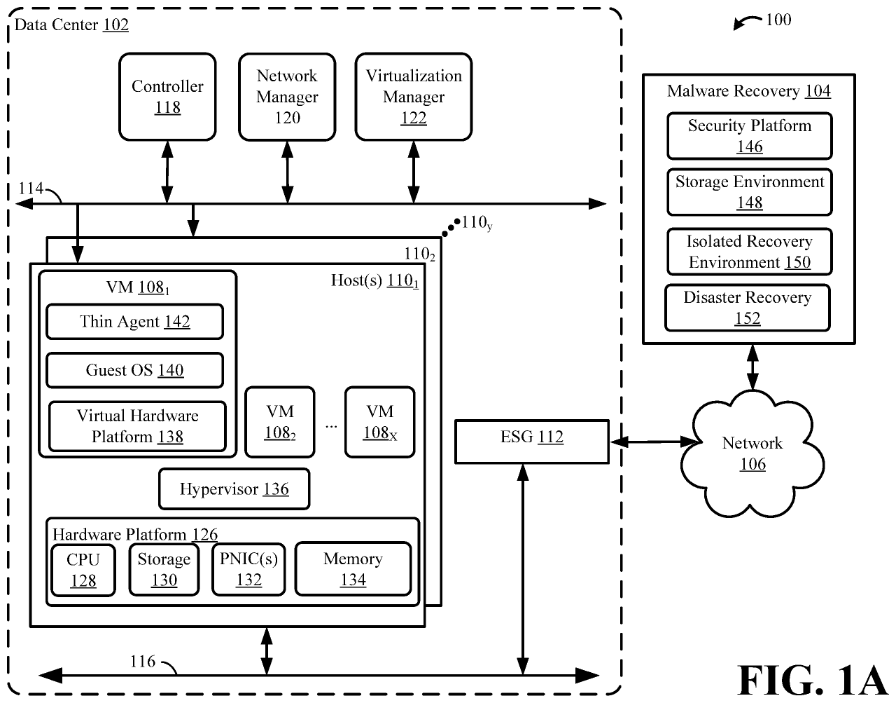

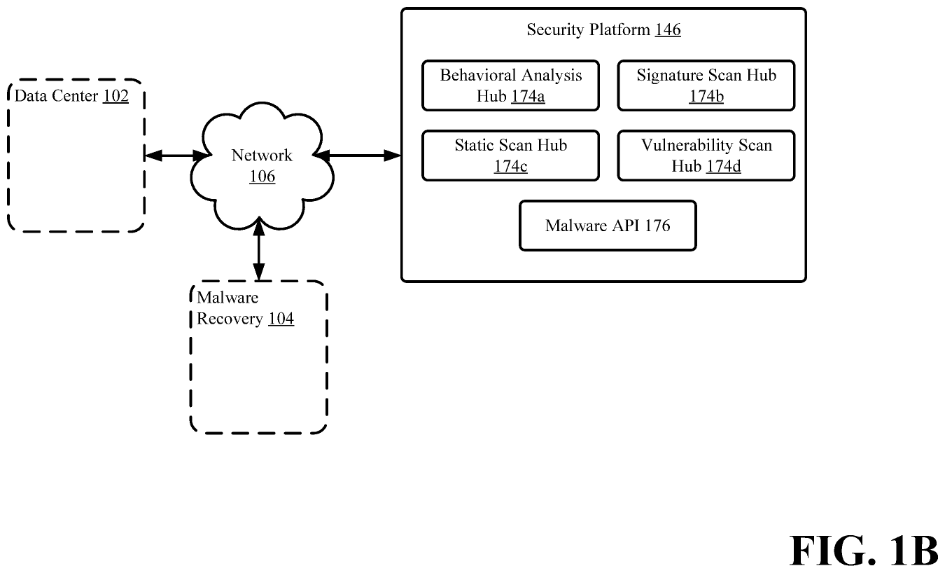

Referring now to the drawings, FIG. 1A depicts example physical and virtual network components in a networking environment 100 in which embodiments of the present application may be implemented. Networking environment 100 includes a data center 102 and a malware recovery environment 104, coupled together via a network 106. The data center 102 may include one or more physical computing devices e.g., running one or more virtual machines (VMs) 108. Malware recovery environment 104 may similarly include one or more physical computing devices running one or more backups to the VMs 108, as described in more detail below. Depending on the particular embodiment, data center 102 may be configured as a cloud data center or an on-premises data center.

Data center 102 and malware recovery environment 104 may communicate via the network 106. Network 106 may be an external network. Network 106 may be a layer 3 (L3) physical network. Network 106 may be a public network, a wide area network (WAN) such as the Internet, a direct link, a local area network (LAN), another type of network, or a combination of these.

Data center 102 includes one or more hosts 110 (e.g., 110₁, 110₂, . . . , 110_{y}) an edge services gateway (ESG) 112, a management network 114, a data network 116, a controller 118, a network manager 120, and a virtualization manager 122. Management network 114 and data network 116 may be implemented as separate physical networks or as separate virtual local area networks (VLANs) on the same physical network.

Host(s) 110 may be communicatively connected to both management network 114 and data network 116. Management network 114 and data network 116 are also referred to as physical or “underlay” networks, and may be separate physical networks or the same physical network as discussed. As used herein, the term “underlay” may be synonymous with “physical” and refers to physical components of networking environment 100. As used herein, the term “overlay” may be used synonymously with “logical” and refers to the logical network implemented at least partially within networking environment 100.

Each of hosts 110 may be constructed on a hardware platform 126, which may be server grade, such as an x86 architecture platform. Hosts 110₁, . . . 110_{y} (collectively or individually referred to as host(s) 110) may be geographically co-located servers on the same rack or on different racks. In some embodiments, one or more of the hosts 110 may be located remote from the data center 102 and/or as part of a different data center and coupled to the network 106.

Hardware platform 126 of a host 110 may include components of a computing device such as at least one processor (CPUs) 128, storage 130, one or more network interfaces (e.g., physical network interface cards (PNICs) 132), system memory 134, and other components (not shown). A CPU 128 is configured to execute instructions, for example, executable instructions that perform one or more operations described herein and that may be stored in the memory and storage system. The network interface(s) enable host 110 to communicate with other devices via a physical network, such as management network 114 and data network 116.

Each host 110 may be configured to provide a virtualization layer, also referred to as a hypervisor 136. The hypervisor 136 abstracts processor, memory, storage, and networking physical resources of hardware platform 126 into a number of virtual machines (VMs) 108₁, . . . 108ₓ (collectively or individually referred to as VM(s) 108) on hosts 110. As shown, multiple VMs 108 may run concurrently on the same host 110.

A virtual machine 108 implements a virtual hardware platform 138 that supports the installation of a guest OS 140 which is capable of executing one or more applications. Guest OS 140 may be a standard, commodity operating system. Examples of a guest OS include Microsoft Windows, Linux, and the like. In some examples, guest OS 140 includes a native file system layer, for example, either a new technology file system (NTFS) or an ext3 type file system layer. This file system layer interfaces with virtual hardware platform 138 to access, from the perspective of guest OS 140, a data storage host bus adapter (HBA), which in reality, is a virtual HBA implemented by virtual hardware platform 138 that provides the appearance of disk storage support to enable execution of guest OS 140 transparent to the virtualization of the system hardware. Although, from the perspective of guest OS 140, file system calls initiated by guest OS 140 to implement file system-related data transfer and control operations appear to be routed to virtual disks for final execution, in reality, such calls are processed and passed through the virtual HBA to hypervisor 136. In particular, the data transfer and control operations may be passed through various layers of hypervisor 136 to true hardware HBAs or physical network interface cards (PNICs).

In certain aspects, each VM 108 includes a container engine installed therein and running as a guest application under control of guest OS 140. Specifically, a container engine is a process that enables the deployment and management of virtual instances (referred to interchangeably herein as “containers”) by providing a layer of OS-level virtualization on guest OS 140 within VM 108.

Each hypervisor 136 may run in conjunction with an operating system (OS) in its respective host 110. In some embodiments, hypervisors can be installed as system level software directly on hardware platforms of its respective host 110 (e.g., referred to as “bare metal” installation) and be conceptually interposed between the physical hardware and the guest OSs executing in the VMs 108. Though certain aspects are described herein with respect to VMs 108 running on hosts 110, it should be understood that such aspects are similarly applicable to physical machines, like hosts 110, without the use of virtualization.

ESG 112 is configured to operate as a gateway device that provides components in data center 102 with connectivity to an external network, such as network 106. ESG 112 may be addressable using addressing of the physical underlay network (e.g., network 106). ESG 112 may manage external public IP addresses for VMs 108. ESG 112 may include a router (e.g., a virtual router and/or a virtual switch) that routes traffic incoming to and outgoing from data center 102. ESG 112 also provides other networking services, such as firewalls, network address translation (NAT), dynamic host configuration protocol (DHCP), and load balancing. ESG 112 may be referred to as a nested transport node, for example, as the ESG 112 does encapsulation and decapsulation. ESG 112 may be a stripped down version of a Linux transport node, with the hypervisor module removed, tuned for fast routing. The term, “transport node” refers to a virtual or physical computing device that is capable of performing packet encapsulation/decapsulation for communicating overlay traffic on an underlay network.

While ESG 112 is illustrated in FIG. 1 as a component outside of host 110, in some embodiments, ESG 112 may be situated on host 110 and provide networking services, such as firewalls, NAT, DHCP, and load balancing services as an SVM.

In some embodiments, thin agent 142 may be implemented as a component on each VM 108. According to certain aspects described herein, thin agent 142 running within a VM 108 intercepts files, processes, network events, etc. on VM 108. For example, thin agent 142 may register with a guest OS 140 running on VM 108 to receive information about such events from the guest OS. In some embodiments, thin agent 142 may be configured as a security sensor for running one or more security operations related to a backup, as described in more detail below.

Data center 102 also includes a management plane and a control plane. The management plane and control plane each may be implemented as single entities (e.g., applications running on a physical or virtual compute instance), or as distributed or clustered applications or components. In some embodiments, a combined manager/controller application, server cluster, or distributed application, may implement both management and control functions. In some embodiments, network manager 120 at least in part implements the management plane and controller 118 at least in part implements the control plane.

The control plane determines the logical overlay network topology and maintains information about network entities such as logical switches, logical routers, and endpoints, etc. The logical topology information is translated by the control plane into network configuration data that is then communicated to network elements of host(s) 110. Controller 118 generally represents a control plane that manages configuration of VMs 108 within data center 102. Controller 118 may be one of a plurality of controllers executing on various hosts 110 in the data center 102 that together implement the functions of the control plane in a distributed manner. Controller 118 may be a computer program that resides and executes in the data center 102 or, in some aspects, controller 118 may run as a virtual appliance (e.g., a VM 108) in one of hosts 110. Although shown as a single unit, it should be understood that controller 118 may be implemented as a distributed or clustered system. That is, controller 118 may include multiple servers or virtual computing instances that implement controller functions. It is also possible for controller 118 and network manager 120 to be combined into a single controller/manager. Controller 118 collects and distributes information about the network from and to endpoints in the network. Controller 118 is associated with one or more virtual and/or physical CPUs. Processor(s) resources allotted or assigned to controller 118 may be unique to controller 118, or may be shared with other components of the data center 102. Controller 118 communicates with hosts 110 via management network 114, such as through control plane protocols. In some embodiments, controller 118 implements a central control plane (CCP).

Network manager 120 and virtualization manager 122 generally represent components of a management plane that include one or more computing devices responsible for receiving logical network configuration inputs, such as from a user or network administrator, defining one or more endpoints and the connections between the endpoints, as well as rules governing communications between various endpoints.

In some embodiments, virtualization manager 122 is a computer program that executes in a server in data center 102 (e.g., the same or a different server than the server on which network manager 120 executes), or in some aspects, virtualization manager 122 runs in one or more of VMs 108. Virtualization manager 122 is configured to carry out administrative tasks for data center 102, including managing hosts 110, managing VMs 108 running within each host 110, provisioning VMs 108, transferring VMs 108 from one host 110 to another host 110, transferring VMs 108 between data centers 102, transferring application instances between VMs 108 or between hosts 110, and load balancing among hosts 110 within data center 102. Virtualization manager 122 takes commands as to creation, migration, and deletion decisions of VMs 108 and application instances on the data center 102. However, virtualization manager 122 also makes independent decisions on management of local VMs 108 and application instances, such as placement of VMs 108 and application instances between hosts 110. In some embodiments, virtualization manager 122 also includes a migration component that performs migration of VMs 108 between hosts 110, such as by live migration.

In some embodiments, network manager 120 is a computer program that executes in a central server in networking environment 100, or in some embodiments, network manager 120 may run in a VM 108, e.g., in one of hosts 110. Network manager 120 communicates with host(s) 110 via management network 114. Network manager 120 may receive network configuration input from a user or an administrator and generate desired state data that specifies how a logical network should be implemented in the physical infrastructure of the data center 102. Further, in certain embodiments, network manager 120 may receive security configuration input (e.g., security policy information) from a user or an administrator and configure hosts 110 and ESG 112 according to this input.

Network manager 120 is configured to receive inputs from an administrator or other entity, e.g., via a web interface or application programming interface (API), and carry out administrative tasks for the data center 102, including centralized network management and providing an aggregated system view for a user.

Also coupled to the network 106 is malware recovery environment 104. Malware recovery environment 104 may be configured to store and/or utilize security platform 146, storage environment 148, isolated recovery environment 150, disaster recovery component 152, and/or other components.

Storage environment 148 may be configured as any storage environment, such as a cloud storage or on-premises storage, for storing backups of VMs 108. In certain aspects, storage environment 148 supports both short-term as well as long-term retention of immutable backups. Storage environment 148 may provide cost optimized backup storage in a steady state operation as well as high-performance primary storage during recovery. As such, storage environment 148 may include a hardware platform, hypervisor, and/or other components similarly depicted in FIG. 1A for fulfilling this purpose. Specifically, embodiments provided herein may be configured for capturing and storing backups of VMs 108 from one or more hosts 110. The backups may be full backups, incremental backups, differential backup, and/or other types of backups and may be stored for a predetermined amount of time, depending on the embodiment. Specifically, some embodiments may store backups for a set duration. Some embodiments may maintain a predetermined number of backups. Some embodiments may rely on an administrator to determine backup retention policies. Other embodiments are also contemplated. Regardless, embodiments described herein are configured to maintain a proper backup for overcoming potential dwell time of ransomware or other malware.

Isolated recovery environment 150 may be configured as a host 110, SDDC, and/or other network secure environment for receiving a backup of a VM 108 for performing malware analysis. As such, the isolated recovery environment 150 may include a hardware platform, similar to hardware platform 126 and/or other hardware described with regard to FIG. 1A. For example, isolated recovery environment 150 may comprise a data center, similar to data center 102, or an individual host, similar to host 110. In some embodiments, isolated recovery environment may be hosted in a public cloud and created programmatically on-demand. Additionally, the disaster recovery component 152 may include an orchestration tool that is configured to cause the isolated recovery environment 150 to remap one or more connections of the backed up VM 108 to make it possible to power on backed up VMs 108 in the isolated recovery environment 150. The disaster recovery component 152 may be a service running on one or more virtual computing instances, directly on a physical computing device, and/or provided as software as a service (SaaS) running in a public cloud. For example, network segments to which the VM 108 was configured as coupled to in the production environment (e.g., in data center 102) may be mapped to corresponding network segments of the isolated recovery environment 150 and production compute resources the VM 108 was configured to use such as hosts or clusters may be mapped to compute resources of isolated recovery environment 150. The orchestration tool may additionally cause the isolated recovery environment 150 to power on backed up VM 108 in the isolated recovery environment 150 using a default network isolation level that provides complete network isolation of the VM 108 except for the flow of collected sensor data to the security platform 146. As described in more detail below, the isolation level may then be adjusted, based on determinations of the security platform 146.

Specifically, some embodiments may be configured to “live mount” the selected backup of VM 108 to the isolated recovery environment 150. Live mounting enables the isolated recovery environment 150 boot the backup of VM 108 directly from snapshots stored securely in the storage environment 148, which acts as a data store, such as a network file system (NFS) and/or non-NFS data store, such as internet small computer interface (iSCI), virtual service area network (vSAN), etc. for the isolated recovery environment 150.

To avoid reinfecting the data center 102 during ransomware recovery, backups are initially restored into isolated recovery environment 150. The isolated recovery environment 150 offers a plurality of different network isolation levels for recovered workloads made available to the administrator. The administrator selects one or more VMs 108 for recovery from a set of VMs 108 covered by a recovery plan. For each selected VM 108, a backup is chosen from a set of available backups in the isolated recovery environment 150. Upon selection, the storage environment 148 makes selected VM 108 backup(s) available to isolated recovery environment 150 or data center 102 via live mount of its NFS data store.

It should be understood that while FIG. 1A depicts security platform 146, storage environment 148, and isolated recovery environment 150, and disaster recovery component 152 as residing in a common malware recovery environment 104, this is merely one example. Depending on the embodiment, one or more of these components may be provided by a separate entity, under a separate infrastructure, via the data center 102, and/or as a SaaS service.

FIG. 1B depicts security platform 146 that operates within the networking environment of FIG. 1A, according to an example embodiment of the present application. As illustrated, security platform 146 may be configured as any local or remote security solution for analyzing a backup of a selected backup of VM 108. Embodiments of the security platform 146 may include a hardware platform, similar to hardware platform 126 and/or other hardware and software for performing a behavioral scan via a behavioral analysis hub 174a, a signature scan via a signature scan hub 174b, a static scan via a static scan hub 174c, a vulnerability scan via a vulnerability scan hub 174d, and/or other analysis for detecting malware. Also included is a malware API 176.

Specifically, once the selected backup of VM 108 is transferred to the isolated recovery environment 150, the disaster recovery component 152 (FIG. 1A) may initiate the security platform 146. Some embodiments of the security platform 146 may utilize a malware API 176 to analyze a selected backup of VM 108. Some embodiments may be configured such that the a thin agent 142 may facilitate security sensor installation following a recovery into isolated recovery environment 150. The thin agent 142 may then facilitate the behavioral analysis via behavioral analysis hub 174a and/or other analysis on the backup of VM 108 and forwards metadata to the security platform 146 for analysis. Examples of such data collection include establishing network connections, downloading files, Windows Registry modifications, etc.

A signature file scan by signature scan hub 174 may also be performed by the security platform 146 on the backup of the VM 108 and may include file signatures (SHA-2, MD5), which may be calculated and compared against a known malware signature database. A static analysis may be performed by static scan hub 174c and may include scanning, parsing, and analyzing executables to extract signals of potential malware without executing binaries. A vulnerability scan may be performed by vulnerability scan hub 174d and includes a scan of installed software in the backup of VM 108 for known vulnerabilities. In-progress scans may generate event and alert streams to the security platform 146.

In some embodiments, the results of security scans are provided to an administrator. In response, any of a plurality of available options may be pursued by the system and/or administrator in response to the scan results. As an example, if no anomalous behavior or known malware of vulnerabilities were detected, the backup may be considered good and could be automatically staged for restoring to a cloud disaster recovery target environment or back to the host 110 that normally runs the VM 108. In some embodiments, if malware is not detected from the default isolation level, the isolation level may be modified to allow additional network communications to continue testing for malware.

Where malware is detected, the backed up version VM 108 may be patched to correct the vulnerability. A VM 108 running in the isolated recovery environment 150 may be patched and then staged for restore. In some embodiments, upon the detection of malware (or a predetermined type of malware) a determination may be made that correction is not possible and may initiate recovery of an earlier version of the VM 108 that may not have the detected issues. Such might be the case if a VM 108 (or backup) being analyzed has been encrypted by malware and is not possible to recover.

The security platform 146 may be configured as an endpoint and workload protection platform with behavioral detection and prevention. Examples of the security platform 146 may include Lastline cloud services and/or Carbon Black cloud services made commercially available from VMware, Inc. of Palo Alto, California. Lastline cloud services and Carbon Black cloud services provide security software that is designed to detect malicious behavior and help prevent malicious files from attacking an organization. In particular, Lastline cloud services and Carbon Black cloud services may be implemented to perform dynamic analysis of files. Dynamic analysis monitors the actions of a file when the file is being executed. Dynamic analysis may also be referred to as behavior analysis because the overall behavior of the sample is captured in the execution phase. Lastline cloud services and Carbon Black cloud services may perform dynamic analysis in a “sandbox,” or other isolated environment (such as isolated recovery environment 150), to ensure that components of data center 102 are not affected in cases where the file executed for analysis contains malware, including ransomware. Also coupled to the network 106 is isolated recovery environment 150. As described in more detail below, the isolated recovery environment 150 may be utilized for isolating a backup of a VM 108 while ransomware detection and remediation is performed.

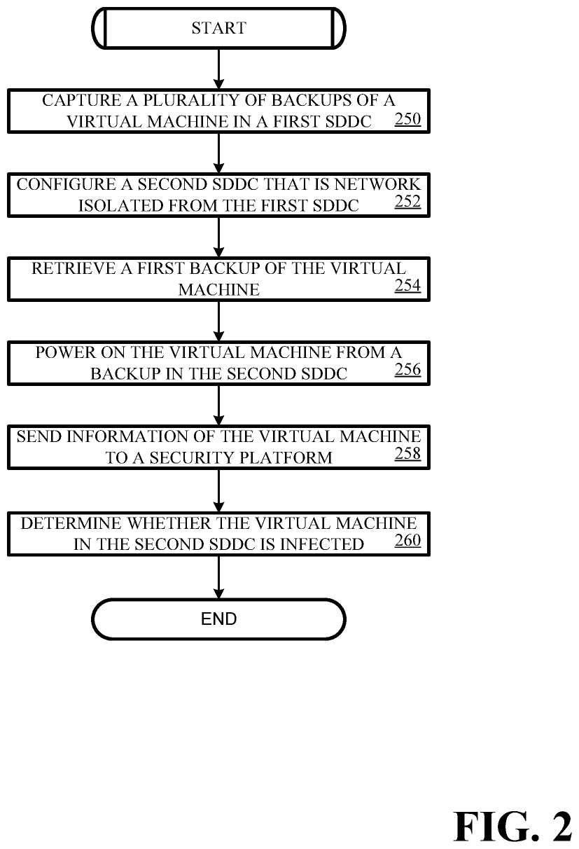

FIG. 2 a flowchart for detecting malware, according to an example embodiment of the present application. As illustrated in block 250, a plurality of backups of a VM 108 may be captured from a first SDDC, such as from host 110 and which are then stored in storage environment 148. In block 252, a second SDDC (e.g., isolated recovery environment 150) may be configured that is network isolated from the first SDDC. As discussed above, the second SDDC may be configured as isolated recovery environment 150.

Accordingly, malware may be detected in the data center 102. This detection may be alerted to an administrator and/or may trigger the actions of block 254. In block 254, a first backup of the VM 108 may be retrieved from the storage environment 148. The first backup of the VM 108 may include configuration information of the VM 108 and data of the VM 108, where the configuration information includes network connectivity information (e.g., physical network and/or logical network, such as an overlay network) of the VM 108 in a first SDDC (e.g., data center 102) running on a first set of host machines. In block 256, the VM 108 may be powered on from the second SDDC. In block 258 information of the virtual machine may be sent to a security platform 146. In block 260, a determination may be made whether the virtual machine in the second SDDC is infected with malware. If the virtual machine in the second SDDC is not able to be repaired, the process may repeated with a second backup being retrieved at block 254.

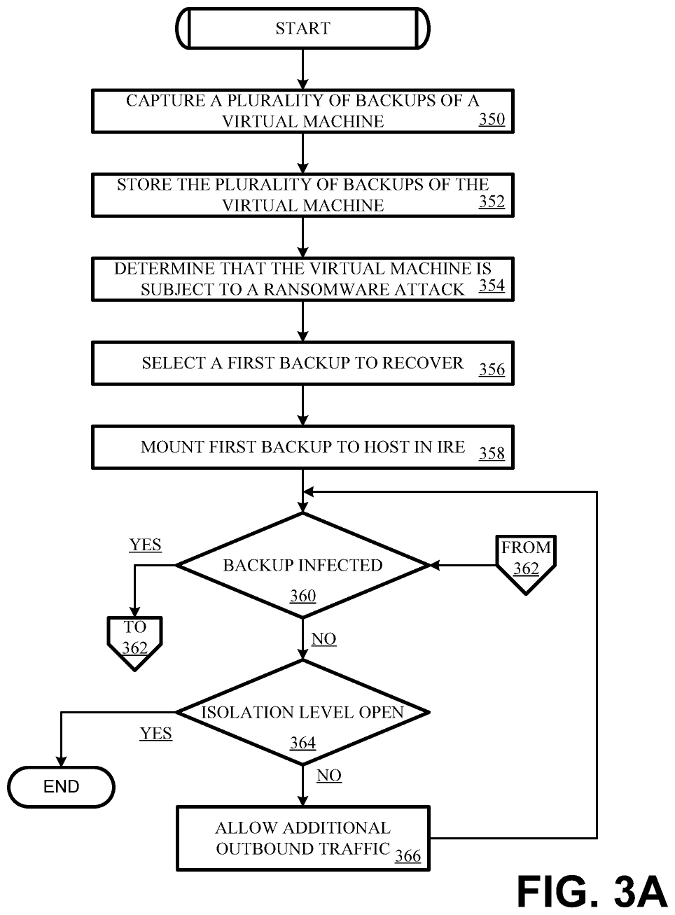

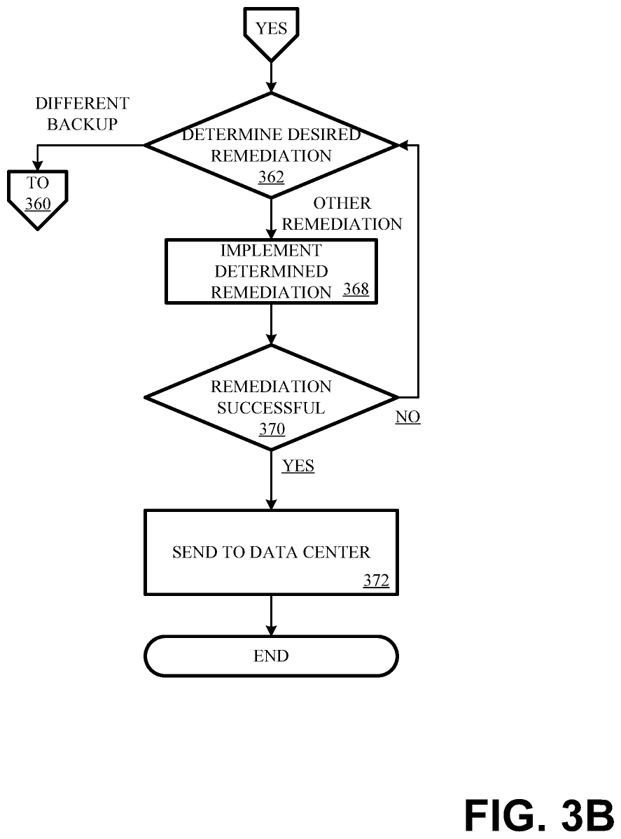

FIGS. 3A, 3B depict a flowchart for detecting and remediating malware, according to an example embodiment of the present application. As illustrated in block 350 of FIG. 3A, a plurality of backups of a virtual machine may be captured. As discussed above, these backups may be incremental backups and/or full backups depending on the particular embodiment. In block 352, the plurality of backups may be stored, such as in storage environment 148. This may be a continual or repetitive process of capturing and storing backups, as well as purging one or more backups due to age or other factors. In block 354, a determination may be made that the virtual machine is infected with malware. This determination may be made automatically due to a ransomware trigger that alerts the administrator of the attack.

Regardless, at block 356, a first backup of the virtual machine 108 may be selected for restoring the virtual machine 108. This determination may be made by an administrator and/or may be made by the system, based on the type of ransomware, industry best practices and/or other factors. As an example, if the system determines that there is a high probability that this type of malware has a dwell time of two weeks, a system determination and or recommendation may be made to select a backup that is at least two weeks old. Some embodiments may simply select the most recent backup and work chronically backwards. Other embodiments are also contemplated.

In block 358, the first backup may be mounted on a host in the isolated recovery environment 150. In mounting the first backup of the VM 108, embodiments may set an isolation level of isolated recovery environment 150 to a default isolation level, which limits outbound communication from the backup of the VM 108. The default isolation level may start at fully isolated and/or less than fully isolated and embodiments may test whether the backup of the VM 108 triggers network communication with an unknown IP address and/or performs other communication-based monitoring to diagnose whether the first backup is infected with malware.

In block 360, a determination is made regarding whether the current backup is infected with malware. As described above, behavioral data about the VM 108 is sent to the security platform 146 for analysis. In some embodiments, the first backup of the VM 108 may first be run in the isolated recovery environment 150 for a predetermined time. In some embodiments, the first backup of the VM 108 may be manipulated to provoke the malware to encrypt the first backup of the virtual machine. Regardless, if the security platform 146 determines that the current backup is infected, the process proceeds to block 362 in FIG. 3B. If not, the process proceeds to block 364, where a determination is made regarding whether the current isolation of the current backup is fully open (or to a maximum desired level). If so, the security platform 146 may determine that the backup of the VM 108 is not infected and the process may end. If the current isolation level is not at a maximum, the process may proceed to block 366, where a second isolation level is set, where additional outbound traffic is allowed from the backup of the VM 108 and the process returns to block 360 to determine whether the backup is infected.

As illustrated in block 362 in FIG. 3B, a determination is made regarding the desired remediation. As described above, some embodiments may determine whether the first backup may be salvaged by removing and/or quarantining the malicious code. Some embodiments may be configured to proceed to a second backup of the virtual machine 108, such as an older backup than the current backup, and determine whether the second backup is subject to the malware attack. In block 368, the determined remediation is implemented. In block 370, a determination is made regarding whether the remediation was successful. If this validation fails, the process proceeds back to block 362 to determine a desired remediation. If the remediation is successful, in block 372, the current backup may be sent to data center 102 and/or to a cloud disaster recovery target environment.

The various embodiments described herein may employ various computer-implemented operations involving data stored in computer systems. For example, these operations may require physical manipulation of physical quantities usually, though not necessarily, these quantities may take the form of electrical or magnetic signals where they, or representations of them, are capable of being stored, transferred, combined, compared, or otherwise manipulated. Further, such manipulations are often referred to in terms, such as producing, identifying, determining, or comparing. Any operations described herein that form part of one or more embodiments may be useful machine operations. In addition, one or more embodiments also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments may be implemented as one or more computer programs or as one or more computer program modules embodied in one or more computer readable media. The term computer readable medium refers to any data storage device that can store data which can thereafter be input to a computer system computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), NVMe storage, Persistent Memory storage, a CD (Compact Discs), CD-ROM, a CD-R, or a CD-RW, a DVD (Digital Versatile Disc), a magnetic tape, and other optical and non-optical data storage devices. The computer readable medium can be a non-transitory computer readable medium. The computer readable medium can also be distributed over a network coupled computer system so that the computer readable code is stored and executed in a distributed fashion. In particular, one or more embodiments may be implemented as a non-transitory computer readable medium comprising instructions that, when executed by at least one processor of a computing system, cause the computing system to perform a method, as described herein.

Although one or more embodiments of the present application have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of one or more embodiments. In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s). In the claims, elements and/or steps do not imply any particular order of operation, unless explicitly stated in the claims.

We claim:

1. A method for virtual computing instance remediation, the method comprising:
retrieving a first backup of a virtual machine from storage, the first backup of the virtual machine comprising configuration information of the virtual machine and data of the virtual machine, the configuration information comprising network connectivity information of the virtual machine in a first software defined data center (SDDC) running on a first set of host machines;
configuring a second SDDC running on a second set of host machines based on the configuration information, wherein the second SDDC is network isolated from the first SDDC;
powering on the virtual machine from the first backup in the second SDDC;
sending, from the virtual machine to a security platform, behavior information of the virtual machine running in the second SDDC; and
determining, based on the behavior information, whether the virtual machine running in the second SDDC is infected with malware.

2. The method of claim 1, further comprising:
in response to determining that the virtual machine running in the second SDDC is infected with malware, sending a second backup of the virtual machine to the second SDDC and determining whether the second backup of the virtual machine is infected with malware.

3. The method of claim 1, further comprising:
in response to determining that the virtual machine running in the second SDDC is infected with malware, removing malicious data associated with the malware.

4. The method of claim 3, wherein:
wherein determining that the virtual machine running in the second SDDC is infected with malware includes performing at least one of the following: a behavioral scan, a signature scan, a static analysis, or a vulnerability scan.

5. The method of claim 1, wherein:
determining whether the first backup of the virtual machine is infected with malware further includes manipulating the first backup of the virtual machine to provoke the malware to encrypt the first backup of the virtual machine.

6. The method of claim 1, wherein:
determining whether the virtual machine running in the second SDDC is infected with malware further includes running the virtual machine with a default isolation level, determining that malware is not detected at the default isolation level, and running the virtual machine in a second isolation level that allows more outbound data than the default isolation level.

7. The method of claim 1, wherein:
sending the virtual machine to the second SDDC includes live mounting the virtual machine in the second SDDC.

8. A system comprising:
at least one processor; and
at least one memory, the at least one processor and the at least one memory configured to cause the system to:
retrieve a first backup of a virtual machine from a storage environment, the first backup of the virtual machine comprising data of the virtual machine and network connectivity information of the virtual machine in a first software defined data center (SDDC) running on a first set of host machines;
configure a second SDDC running on a second set of host machines based on the network connectivity information, wherein the second SDDC is network isolated from the first SDDC;
power on the virtual machine from the first backup in the second SDDC;
send, from the virtual machine to a security platform, behavior information of the virtual machine running in the second SDDC; and
determine, based on the behavior information, whether the virtual machine running in the second SDDC is infected with malware.

9. The system of claim 8, wherein the at least one processor and the at least one memory are further configured to cause the system to:
in response to determining that the virtual machine running in the second SDDC is infected with malware, sending a second backup of the virtual machine to the second SDDC and determining whether the second backup of the virtual machine is infected with malware.

10. The system of claim 8, wherein the at least one processor and the at least one memory are further configured to cause the system to:
in response to determining that the virtual machine running in the second SDDC is infected with malware, removing malicious data associated with the malware.

11. The system of claim 10, wherein:
determining that the virtual machine running in the second SDDC is infected with malware includes performing at least one of the following: a behavioral scan, a signature scan, a static analysis, or a vulnerability scan.

12. The system of claim 8, wherein:
determining whether the first backup of the virtual machine is infected with malware further includes manipulating the first backup of the virtual machine to provoke the malware to encrypt the first backup of the virtual machine.

13. The system of claim 8, wherein:
determining whether the virtual machine running in the second SDDC is infected with malware further includes running the virtual machine with a default isolation level, determining that malware is not detected at the default isolation level, and running the virtual machine in a second isolation level that allows more outbound data than the default isolation level.

14. The system of claim 8, wherein:
sending the virtual machine to the second SDDC includes live mounting the virtual machine in the second SDDC.

15. A non-transitory computer-readable medium comprising instructions that, when executed by at least one processor of a computing system, cause the computing system to perform operations for virtual computing instance remediation, the operations comprising:
retrieve a first backup of a virtual machine from storage, the first backup of the virtual machine comprising configuration information of the virtual machine and data of the virtual machine, the configuration information comprising network connectivity information of the virtual machine in a first software defined data center (SDDC) running on a first set of host machines;
configure a second SDDC running on a second set of host machines based on the configuration information, wherein the second SDDC is network isolated from the first SDDC;
power on the virtual machine from the first backup in the second SDDC;
send, from the virtual machine to a security platform, behavior information of the virtual machine running in the second SDDC;
determine, based on the behavior information, whether the virtual machine running in the second SDDC is infected with malware; and
in response to determining that the virtual machine running in the second SDDC is infected with malware, remediate the malware.

16. The non-transitory computer-readable medium of claim 15, wherein remediating the malware comprises:
sending a second backup of the virtual machine to the second SDDC and determining whether the second backup of the virtual machine is infected with malware.

17. The non-transitory computer-readable medium of claim 15, wherein:
determining that the virtual machine running in the second SDDC is infected with malware includes performing at least one of the following: a behavioral scan, a signature scan, a static analysis, or a vulnerability scan.

18. The non-transitory computer-readable medium of claim 15, wherein:
determining whether the first backup of the virtual machine is infected with malware further includes manipulating the first backup of the virtual machine to provoke the malware to encrypt the first backup of the virtual machine.

19. The non-transitory computer-readable medium of claim 15, wherein:
determining whether the virtual machine running in the second SDDC is infected with malware further includes running the virtual machine with a default isolation level, determining that malware is not detected at the default isolation level, and running the virtual machine in a second isolation level that allows more outbound data than the default isolation level.

20. The non-transitory computer-readable medium of claim 15, wherein:
sending the virtual machine to the second SDDC includes live mounting the virtual machine in the second SDDC.
